(19) United States
(12) Patent Application Publication
(10) Pub. No.: US 2024/0270969 A1
(43) Pub. Date: Aug. 15, 2024

(54) AEROGEL MODIFIED BITUMINOUS BINDERS AND MIXTURES

(71) Applicant: Arizona Board of Regents on behalf of Arizona State University, Scottsdale, AZ (US)

(72) Inventors: Kamil Elias Kaloush, Scottsdale, AZ (US); Carlos Javier Obando Gamboa, Tempe, AZ (US); Jolina Karam, Tempe, AZ (US)

(21) Appl. No.: 18/564,929

(22) PCT Filed: Jun. 10, 2022
(86) PCT No.: PCT/US2022/072868

§ 371 Date: Nov. 28, 2023

Related U.S. Application Data
(60) Provisional application No. 63/210,891, filed on Jun. 15, 2021.

(51) Int. Cl. C08L 95/00; C08J 9/33; C08J 9/36; C08K 9/10

(52) U.S. Cl. CPC C08L 95/00; C08J 9/33; C08J 9/365; C08K 9/10; C08J 2205/026; C08J 2395/00; C08K 2201/005

(57) ABSTRACT

An acrogel composite includes aerogel particles and an encapsulator. The aerogel particles are coated with the encapsulator to yield an acrogel composite. Making an aerogel composite includes combining an encapsulator and aerogel particles, mixing the encapsulator and the aerogel particles to yield a granular blend including coated acrogel particles, and increasing a rate of mixing over a length of time to yield the aerogel composite.

### CROSS-REFERENCE TO RELATED APPLICATION

This application claims the benefit of U.S. Patent Application No. 63/210,891 filed on Jun. 15, 2021, which is incorporated by reference herein in its entirety.

### TECHNICAL FIELD

This invention relates to aerogel composites including aerogel-modified bituminous binders and mixtures.

### BACKGROUND

Asphalt pavement mixtures are mainly composed of bitumen (e.g., as a binder) mixed with differently sized mineral aggregates. Asphalt binders have viscoelastic properties and are influenced by environmental and temperature conditions. Thermal susceptibility of asphalt pavement causes high temperatures to induce a softening behavior of the bitumen and low temperatures to induce stiffening, leading to a brittle behavior. These conditions will lead to cracks and fissures due to the accumulated thermal stresses within the structure. Asphalt pavements require maintenance involving crack sealing and surface treatments in order to address these problems.

### SUMMARY

This disclosure describes aerogel composites using aerogel, polymer-crosslinked aerogels, or both, in granular or powder form, and an encapsulator. The encapsulator can include co-products of the petroleum-refinery system (e.g., heavy oil products, asphalt binders) or compatible materials (e.g., synthetic polymers or organic polymers such as bio-derived compounds). The aerogel and the encapsulator are blended to yield the composite. Examples of the aerogel composites include aerogel modified bituminous materials (aMBx). Bituminous materials include asphalt binders and mixtures. Aerogel composite encapsulated with organic polymer includes highly viscous bio-derived compounds.

Embodiment 1 is an aerogel composite comprising:

aerogel particles; and

an encapsulator, wherein the aerogel particles are coated with the encapsulator to yield an aerogel composite.

Embodiment 2 is a composite of embodiment 1, wherein the aerogel particles comprise silica, carbon, metal oxide, polymer-crosslinked aerogels, or any combination thereof.

Embodiment 3 is a composite of embodiment 1 or 2, wherein a particle size of the aerogel is in a range between 0.005 mm and 2 mm.

Embodiment 4 is a composite of any one of embodiments 1 through 3, wherein the encapsulator comprises a heavy oil product, an asphalt binder, a synthetic polymer, an organic polymer, or any combination thereof.

Embodiment 5 is a composite of embodiment 4, wherein the organic polymer comprises a bio-derived compound, a bio-oil, lignin, industrial lignin, tree resin, or any combination thereof.

Embodiment 6 is a composite of any one of embodiments 1 through 5, wherein a particle size of the aerogel composite is in a range between 0.01 mm and 3 mm.

Embodiment 7 is a composite of any one of embodiments 1 through 6, comprising a weight ratio of aerogel to encapsulator in a range between 10:90 and 90:10.

Embodiment 8 is method of making an aerogel composite, the method comprising: combining an encapsulator and aerogel particles;

mixing the encapsulator and the aerogel particles to yield a granular blend comprising coated aerogel particles; and increasing a rate of mixing over a length of time to yield the aerogel composite.

Embodiment 9 is a method of embodiment 8, wherein the encapsulator comprises a heavy oil product, an asphalt binder, a synthetic polymer, an organic polymer, or any combination thereof.

Embodiment 10 is a method of embodiment 9, wherein the organic polymer comprises a bio-derived compound, a bio-oil, lignin, industrial lignin, tree resin, or any combination thereof.

Embodiment 11 is a method of any one of embodiments 8 through 10, wherein the aerogel particles comprise silica, carbon, metal oxide, polymer-crosslinked aerogels, or any combination thereof.

Embodiment 12 is a method of any one of embodiments 8 through 11, wherein a particle size of the aerogel particles is in a range between 0.005 mm and 2 mm.

Embodiment 13 is a method of any one of embodiments 8 through 12, wherein a particle size of the aerogel composite is in a range between 0.01 mm and 3 mm.

Embodiment 14 is a method of any one of embodiments 8 through 13, wherein a weight ratio of the aerogel to the encapsulator is in a range between 10:90 and 90:10.

Embodiment 15 is a method of any one of embodiments 8 through 14, wherein a weight ratio of the aerogel to the encapsulator is in a range between 10:90 and 90:10.

Embodiment 16 is a method of any one of embodiments 8 through 15, comprising increasing the rate of mixing from 750 RPM to 3500 RPM.

Embodiment 17 is a method of any one of embodiments 8 through 16, wherein the length of mixing time is between 1 minute and 10 minutes.

Embodiment 18 is a method of modifying bituminous material, the method comprising:

heating the bituminous material;

combining the aerogel composite of any one of embodiments 1 through 17 with the bituminous material; and mixing the aerogel composite and the bituminous material to uniformly distribute the aerogel composite in the bituminous material.

Embodiment 19 is a method of embodiment 18, wherein a weight ratio of the aerogel composite to the bituminous material is in a range between 10:90 and 90:10.

Embodiment 20 is a method of making an asphalt mixture, the method comprising:

combining the aerogel composite of any one of embodiments 1 through 19, an asphalt binder, and aggregate to yield the asphalt mixture.

Embodiment 21 is a method of embodiment 20, further comprising: combining the aerogel composite and the asphalt binder to yield an aerogel composite binder mixture; and combining the aerogel composite binder mixture with the aggregate to yield the asphalt mixture.

Advantages of the aMBx described in this disclosure include thermal resistance, durability, and reduced heat conduction/storage for urban cooling benefits. In the application of asphalt mixtures and pavements, an aMBx modified mixture used for hot, warm, or cold applications provides performance benefits addressing common shortcomings of asphalt pavements (e.g., high temperature deformation and thermal cracking). Other beneficial applications for bituminous materials include asphalt emulsions used in different road surface treatments, asphalt roofing shingles, and asphalt sealants used for crack repairs and joints protection.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows phase angle at 82° C., 10 rad/sec for 3 different binders as a function of aMBx content.

FIG. 2 shows G*at 82° ° C., 10 rad/sec for 3 different binders as a function of aMBx content.

FIG. 3 shows master curve of control (0%), 10%, and 30% aMBx.

FIG. 4 shows temperature change at the top of the pavement.

FIG. 5 shows temperature change at the bottom of the pavement.

FIG. 6 shows strain variation as a function of temperature change over time.

### DETAILED DESCRIPTION

This disclosure describes composites including a mesoporous, open-celled, solid foam (i.e., aerogel) combined with an encapsulator. Bituminous material can be modified with the composite to yield aerogel modified bituminous materials (aMBx). An aerogel is a low-density solid-state material, derived from a gel in which the liquid component of the gel has been replaced with gas (e.g., air). The encapsulator can include co-products of the petroleum-refinery system (e.g., heavy oil products, asphalt binders) or compatible materials (e.g., synthetic polymers, organic polymers such as bio-derived compounds, bio-oils, lignin, industrial lignin, tree resin, or any combination thereof). The aerogel and the encapsulator are blended in selected amounts to yield the composite.

An aerogel includes a system of interconnected nanostructures having a porosity of at least 50%. Aerogels can be fabricated from silica, carbon, metal oxide, polymer-crosslinked aerogels, or any combination thereof, in granular or powder form. Aerogel is a low density porous solid that can function as a thermal insulator. The aerogel particles can have different colors. In some cases, the aerogel particles are transparent. Super-insulating silica aerogels typically exhibit low thermal conductivity. Aerogel particles are generally considered to be hazardous. They have a very low density and typically require careful grinding and handling procedures (e.g., a fume hood, blast shield, non-flammable lab coat, specific gloves). These issues can be exacerbated in field production at asphalt plants as the lightweight particles can cause dust clouds and ignite.

The encapsulator adds weight to the aerogel particle and reduces the probability of aerosol suspension of the aerogel particles. Suitable encapsulators include co-products of the petroleum-refinery system (e.g., heavy oil products, asphalt binders) or compatible materials (e.g., synthetic polymers, organic polymers such as bio-derived compounds, bio-oils, lignin, industrial lignin, tree resin, or any combination thereof.). The encapsulator facilitates blending of the aerogel with other bituminous materials such as asphalt emulsions used in different road surface treatments, asphalt mixtures, asphalt roofing shingles, and asphalt sealants (for use in crack repairs and joint protection).

In aerogel modified bituminous binders and mixtures, aerogel particles are ground and blended as part of the composite. The aMBx materials can provide cooling in urban environments. The aMBx is suitable for different infrastructure applications. As a component of asphalt mixtures and pavements, an aMBx modified mixture used in hot, warm, or cold applications can prevent high temperature deformation and thermal cracking. The aMBx material can provide resistance to temperature susceptibility and reduced heat conduction/storage compared with unmodified asphalt, therefore contributing to urban cooling. Other applications for bituminous materials include asphalt emulsions used in different road surface treatments, asphalt roofing shingles, and asphalt sealants used for crack repairs and joint protection.

The aerogel and encapsulator composite can be combined in a weight ratio between 10:90 to 90:10 of aerogel to encapsulator. These components can be mixed using a high-speed mixer. The aerogel is pulverized to a specific range of particle sizes to ensure proper coating and a homogeneous product. These elements are then placed in a metallic container that is locked in a heated chamber. Depending on the needs and type of encapsulator, the process of mixing occurs in a range of temperatures. For aMBx, this temperature range is between 180° C. and 210° C. over 2 to 5 minutes. The number of revolutions per minute varies from 750 to 3500 RPM in a batch mixing, starting from the lowest RPM and finishing with the highest. The length of the mixing time is typically between 1 minute and 10 minutes.

The encapsulation adds weight to the aerogel particles and helps to prevent them from forming dust clouds during mixing or handling. The aerogel composite, and thus the thermal insulative properties of aerogels, are incorporated into bituminous materials and are distributed within the mastic.

The aerogel can be in the form of particles. The aerogel composite can be any shape selected from a particle, flake, sheet, crumb, grain, pellet, granule, etc. Here, “particle size” typically refers to the average diameter of the particles. When the particles are of non-spherical shape, the term refers to the average equivalent diameter of the particle, namely the diameter of an equivalent spherical particle based on the longest dimension of the particle. The particle size of the aerogel typically ranges between 0.005 mm and 2 mm. When blended with the encapsulator, the aMBx composite can have a particle size ranging between 0.01 and 3 mm.

Preparation of the aerogel composites includes combining the encapsulator and aerogel particles, mixing the encapsulator and the aerogel particles to yield a granular blend comprising coated aerogel particles, heating the granular blend when required, and increasing a rate of mixing over a length of time to yield the aerogel composite. Preparation of the aerogel composites includes a combination of high kinetic energy mixing steps at elevated temperatures. This mixing yields a relatively quick coating of the aerogel particles and a homogeneous blend leading to granular product (aMBx). The mixing is conducted under conditions of high sheer rate (i.e., the mixing is performed under such conditions that high kinetic energy is provided to the mixture while mixing).

Modifying bituminous material includes heating the bituminous material, combining the aerogel with the bituminous material, and mixing the aerogel composite and the bituminous materials to uniformly distribute the aerogel composite in the bituminous materials.

The aMBx have a relatively low thermal conductivity between 0.08 and 0.12 W/m°K and a light-weight density between 0.32 and 0.38 g/cm₃. Consequently, this low thermal conductivity will provide thermal benefits and decreased thermal susceptibility to bituminous materials. Other benefits can be realized by the addition of this modifier.

The aMBx can be combined in any ratio with bituminous materials. In some embodiments, such as paving materials, the aMBx content is added by weight of asphalt binder.

### EXAMPLES

Introduction of aMBx with Asphalt Binders

To add aMBx with asphalt binders, each binder is heated at its maximum operational temperature given by the viscosity analysis. The process typically includes normal stirring until the modifier is blended with the binder. aMBx was added to three different binders (PG58-28, PG64-16 and PG76-22; PG is Performance Grade, numbers designate the range of temperature performance in industry specifications). As part of the asphalt binder modification laboratory work, softening point, rotational viscosity, Dynamic Shear Rheology (DSR), and Multiple Stress Creep Recovery (MSCR) tests were conducted according to international standards (ASTM and AASHTO). The aMBx mixture content is defined as the weight percentage of the aMBx relative to the weight of the binder. The aMBx mixture content of the modified binders in these examples is between 1% aMBx and 30% aMBx. Adding aMBx to the bitumen decreased the thermal susceptibility of the bitumen, decreased the permanent deformation, and increased percentage recovery.

One indicator of the improvement of the asphalt binder performance is “softening point.” This value increased with the increase of aMBx content. Higher temperatures were reached in the test, meaning better performance of the asphalt binder. The results obtained are summarized in Tables 1 through 4. Results demonstrate the change in the binder's characteristics when aMBx particles are blended with asphalt binders.

TABLE 1
Performance of Binder PG76-22 modified with different aMBx contents.

| aMBx | Penetration | Softening | | | Jnr 0.1 kPa | % Recovery | Jnr 3.2 kPa | % Recovery | |
|---|---|---|---|---|---|---|---|---|---|
| Content | (0.1 mm) | Point | Ai | VTSi | (1/kPa) | 0.1 kPa | (1/kPa) | 3.2 kPa | New PG |
| Control | 51.75 | 60.50 | 9.44 | −3.12 | 2.77 | 36.93 | 6.3 | 3.20 | 76-22 |
| 1.0% aMBx | 49.00 | 61.00 | 9.28 | −3.05 | | * | * | * | * |
| 2.0% aMBx | 44.75 | 61.50 | 9.05 | −2.97 | 0.77 | 52.18 | 2.72 | 11.3 | 88-22 |
| 3.0% aMBx | 40.75 | 64.00 | 8.96 | −2.94 | 0.59 | 55.01 | 2.09 | 11.68 | 88-22 |
| 6.0% aMBx | 38.00 | 74.50 | 7.96 | −2.57 | 0.21 | 88.38 | 1.30 | 41.78 | 96-22 |
| 10.0% aMBx | 19.50 | 76.00 | 7.35 | −2.34 | 0.03 | 94.97 | 0.27 | 51.93 | >102-22 |
| 15. % aMBx | 13.75 | 88.00 | ** | ** | 0.005 | 95.62 | 0.07 | 68.28 | >102-22 |
| 20.0% aMBx | 10.25 | 92.50 | ** | ** | 0.0003 | 98.10 | 0.002 | 90.92 | >102-22 |

MSCR T° 76° C. DSR PG grading 70-102° C.
* No Tested/** Unavailable Testing

TABLE 2
Summary of Binder Performance: PG76-22, PG64-16 and PG58-28 modified with 10% aMBx

| | | | | | | | | | | | | | Jnr |
|---|---|---|---|---|---|---|---|---|---|---|---|---|---|
| | Pen | | Softening | | | | | | Recovery | | Recovery | | 3.2 kPa |
| Binder | (0.1 mm) | % DIFF | Point (° C.) | % DIFF | Ai | % DIFF | VTSi | % DIFF | 0.1 kPa | % DIFF | 3.2 kPa | % DIFF | (1/kPa) |
| Control | 51.75 | 55% | 60.50 | 33% | 9.44 | 27% | −3.12 | 31% | 36.93 | 150% | 3.20 | 1661% | 6.30 |
| PG76-16 | | | | | | | | | | | | | |
| 10% aMBx | 19.50 | | 76.0 | | 7.35 | | −2.34 | | 94.97 | | 51.93 | | 0.27 |
| in PG76-16 | | | | | | | | | | | | | |
| Control | 55.50 | 66% | 46.00 | 24% | 10.85 | 28% | −3.64 | 31% | −1.27 | 6870% | −2.68 | 131% | 8.75 |
| PG64-16 | | | | | | | | | | | | | |
| 10% aMBx | 18.80 | | 57.00 | | 7.85 | | −2.53 | | 83.98 | | 6.18 | | 0.61 |
| in PG64-16 | | | | | | | | | | | | | |
| Control | 92.75 | 51% | 41.50 | 27% | 10.64 | 28% | −3.57 | 31% | −0.34 | 19615% | −2.20 | 387% | 7.14 |
| PG58-28 | | | | | | | | | | | | | |
| 10% aMBx | 45.25 | | 52.50 | | 7.61 | | −2.45 | | 66.35 | | 10.72 | | 0.41 |
| in PG58-28 | | | | | | | | | | | | | |

MSCR Temperatures: PG76-16 at 76 C., PG64-16 at 64 C. and PG58-28 at 58 C.

TABLE 3
Performance of Binder PG64-16 modified
with different aMBx contents.

| | % Recovery | % Recovery | Jnr 3.2 | |
|---|---|---|---|---|
| aMBx Content | 0.1 kPa | 3.2 kPa | kPa (1/kPa) | PG |
| Control | −1.27 | −2.68 | 8.75 | 64-16 |
| 3.0% aMBx | 4.41 | −1.69 | 5.84 | 70-16 |
| 6.0% aMBx | 27.97 | −0.51 | 3.72 | 76-16 |
| 10.0% aMBx | 83.98 | 6.18 | 0.61 | >88-16 |
| 15.0% aMBx | 85.99 | 9.93 | 0.46 | >96-16 |
| 20.0% aMBx | 96.96 | 49.22 | 0.05 | >96-16 |

MSCR T° 64° C. DSR PG grading 58-88° C.

TABLE 4
Performance of Binder PG58-28 modified
with different aMBx contents.

| | % Recovery | % Recovery | Jnr 3.2 | |
|---|---|---|---|---|
| aMBx Content | 0.1 kPa | 3.2 kPa | kPa (1/kPa) | PG |
| Control | −0.34 | −2.20 | 7.14 | 58-28 |
| 3.0% aMBx | 19.16 | −0.61 | 3.53 | 64-28 |
| 6.0% aMBx | 40.46 | 0.60 | 2.27 | 70-28 |
| 10.0% aMBx | 66.35 | 10.72 | 0.41 | >82-28 |
| 15.0% aMBx | 89.28 | 18.39 | 0.27 | >88-28 |
| 20.0% aMBx | 98.01 | 64.35 | 0.02 | >88-28 |

MSCR T° 58° C. DSR PG grading 52-82

The tests were performed according to ASTM standard test methods for asphalt binders and mixtures. Tests were carried out on a control (non-modified) binder and binders with a range of aMBx content (by weight of binder). The softening point was assessed according to ASTM D 36. The higher the softening point, the less the binder is susceptible to temperature change. The rotational viscosity assessment is conducted according to ASTM D4402. This test ensures that the asphalt binder is sufficiently fluid for pumping and mixing at the plant. This test also provides the “Ai” and “VTSi” parameters, which are indicators of the susceptibility of the binder to temperature change (“VTSi”). The smaller the “VTSi”, the less susceptible the binder to temperature change. The Performance Grade (PG) test is conducted using the Dynamic Shear Rheometer (DSR) per the AASHTO T 315. By adding aMBx, all binders showed improved PG grading, which means that they can perform under a larger range of temperatures.

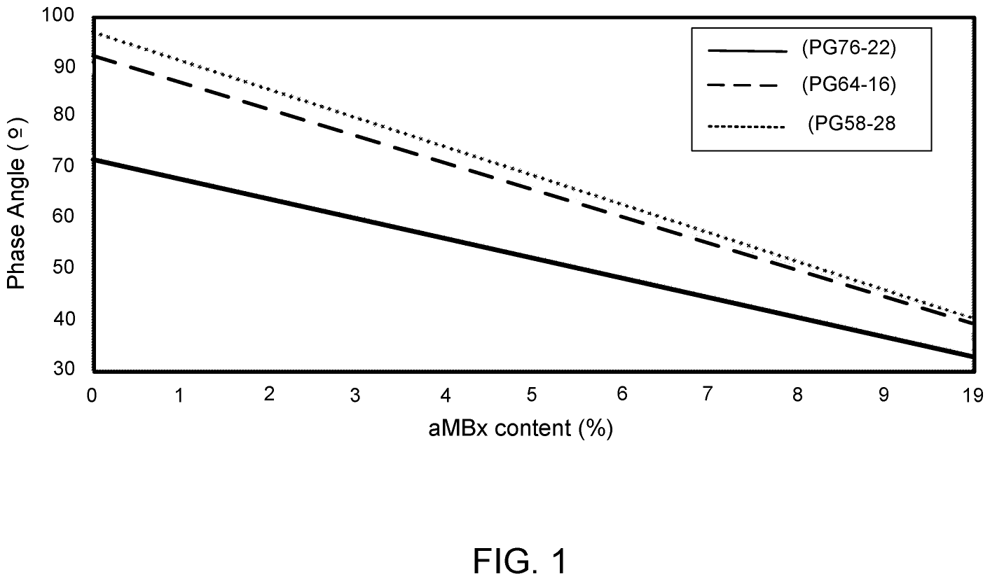

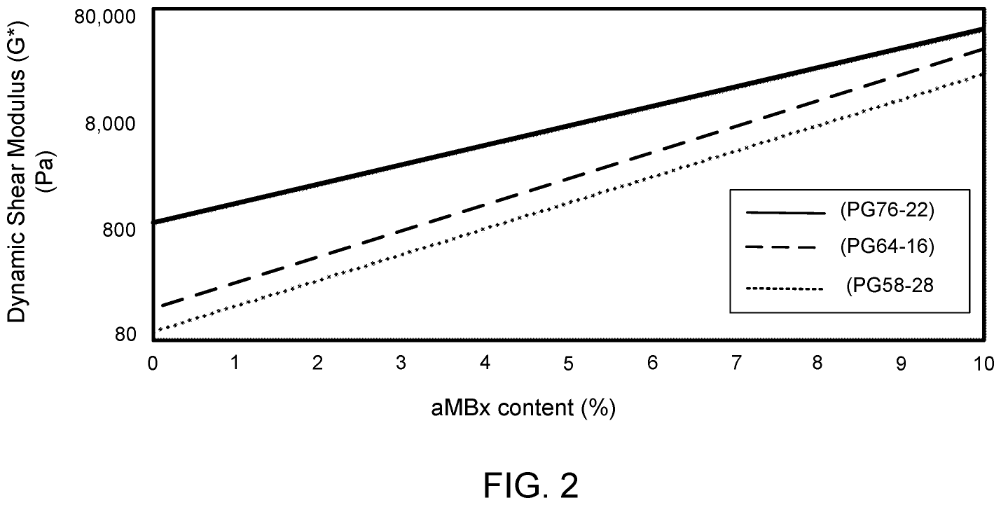

FIGS. 1 and 2 show the DSR results of complex shear modulus G* (in pascals) and phase angle (in degrees) change when adding different aMBx contents. Asphalt binders are viscoelastic, and depending on temperature and loading frequency, they behave partly like elastic solids and viscous liquids. As elastic solids, the deformation induced by the loads is partly recoverable. The DSR is capable of detecting both of these properties by measuring the complex shear modulus “G*” and the phase angle “δ”. The complex shear modulus represents the total resistance to deformation when repeatedly subjected under shear stress, while the phase angle is the lag between the applied shear stress and resulting strain. The phase angle is proportional to the viscosity of the material and the “G*” value is proportional to the stiffness of the binder. These two characteristics are also used to determine the rutting and the fatigue resistance of binders. The stiffer the binder (higher G* value), the higher the resistance to rutting, as the asphalt binder will experience less deformation. The smaller the value of the phase angle, the more elastic the binder and thus the better the fatigue performance. As part of the Superior Performing Asphalt Pavements (Superpave) specifications, the ratio of G* with sin(δ) at a frequency of 10 rad/sec is used to determine the upper temperature of the Performance Grade of the binder.

The Multiple Stress Creep Recovery (MSCR) test was carried out per AASHTO TP70 standards to test the potential of binders for permanent deformation. The response of the MSCR test is different than the response from the PG test. In the PG system, the parameter G*/sin(δ) is measured by applying an oscillating load at low shear strain. In the MSCR test, two different parameters are measured: the Jnr, the non-recoverable creep compliance and the % R, the percent recovery during each loading cycle. Tables 1-4 show that the Jnr values decrease and the % R increases with the increase of aMBx.

The Bitumen Bond Strength (BBS) test was conducted per AASHTO TP-91-15 standards. This test method measures the tensile force needed to pull out a stub adhered to a solid substrate with asphalt binder. The evaluation of the pullout tensile strength on aggregate substrate provides a measure of the asphalt-aggregate compatibility. Table 5 shows that the bonding strength for the binders with the aMBx are comparatively the same as that of the conventional binders. Therefore, the addition of the aMBx did not noticeably affect the bond between the aggregate and the binder.

TABLE 5
BBS (pull-off test) for binders PG76-22, PG64-16 and PG58-28.

| | Tensile Strength (PSI) with different aMBx content | | | | | |
|---|---|---|---|---|---|---|
| Conditions | Control | 3.0% | 6.0% | 10.0% | 15.0% | 20.0% |

BBS (pull-off test) - Binder PG76-22

| | | | | | | |
|---|---|---|---|---|---|---|
| 105° C. | 275.79 | 229.42 | 273.97 | 270.12 | 269.21 | 276.36 |
| COV (3 samples) | 5.0% | 1.5% | 3.8% | 1.9% | 1.9% | 3.4% |

| | | |
|---|---|---|
| TYPE OF FAILURE BY | COHESION | ADHESION |

BBS (pull-off test) - Binder PG64-16

| | | | | | | |
|---|---|---|---|---|---|---|
| 75° C. | 261.35 | 144.26 | 136.92 | 279.21 | 157.72 | 139.75 |
| COV (3 samples) | 7.1% | 5.0% | 0.9% | 3.3% | 13.9% | 8.0% |

| | |
|---|---|
| TYPE OF FAILURE BY | COHESION |

BBS (pull-off test) - Binder PG58-28

| | | | | | | |
|---|---|---|---|---|---|---|
| 75° C. | 230.09 | 112.16 | 112.26 | 247.24 | 102.86 | 94.73 |
| COV (3 samples) | 4.0% | 4.8% | 11.3% | 1.0% | 13.9% | 8.9% |

| | |
|---|---|
| TYPE OF FAILURE BY | COHESION |

Table 6 shows the results of a thermal conductivity test. The method used to measure the thermal conductivity of binder PG76-22 was developed at the National Center of Excellence for SMART Innovations at Arizona State University. To perform the test, binder samples were poured into a cylindrical silicon mold with a height of 25 mm, a half-height indent of 2 mm in the center, and a total radius of 20 mm. Thermocouples were placed on the sample to measure the temperature change between the sample's inner and outer layers. Table 6 lists thermal conductivity of binder PG76-22 with different aMBx content. As shown in Table 6, the aMBx samples exhibited lower thermal conductivity values than the control. The thermal conductivity is proportional to the amount of heat the sample conducts.

TABLE 6
Thermal conductivity of binder PG76-22
with different aMBx content.

| | Thermal Conductivity |
|---|---|
| Type of Sample | (W/m° K) |
| CONTROL | 0.223 |
| 3.0% aMBx | 0.211 |
| 6.0% aMBx | 0.201 |
| 10.0% aMBx | 0.189 |
| 15.0% aMBx | 0.176 |

Asphalt Mixture Design and Introduction of aMBx in Paving Mixtures

A Hot Mixture Asphalt (HMA) mixture design is a procedure to determine the aggregates, asphalt binder to use, and the optimum combination of these two ingredients. This process addresses performance indicators such as deformation, fatigue, and low temperature crack resistance. Additionally, the asphalt design mixture is preferably durable, moisture damage resistant, and workable.

Two methods were used to form the asphalt mixture: the Dry Method (DM) and Wet Method (WM). During preparation of asphalt using the Dry Method, aMBx can be added while mixing the aggregates, or both the aggregates and the binder. In the Wet Method, the composite is blended first with the asphalt binder, then this binder plus aMBx (aMBx-binder) is added to the raw aggregates later. The distribution of the aMBx particles in the mixture differs for these two methods used to introduce the aMBx into the asphalt mixtures. The properties of the modified asphalt mixture with aMBx are better when the Wet Method is used compared to the Dry Method. This suggests that the distribution of the aMBx particles is more uniform when the aMBx is first mixed with the hot binder, rather than with the aggregates.

### Asphalt Mixture Performance Tests

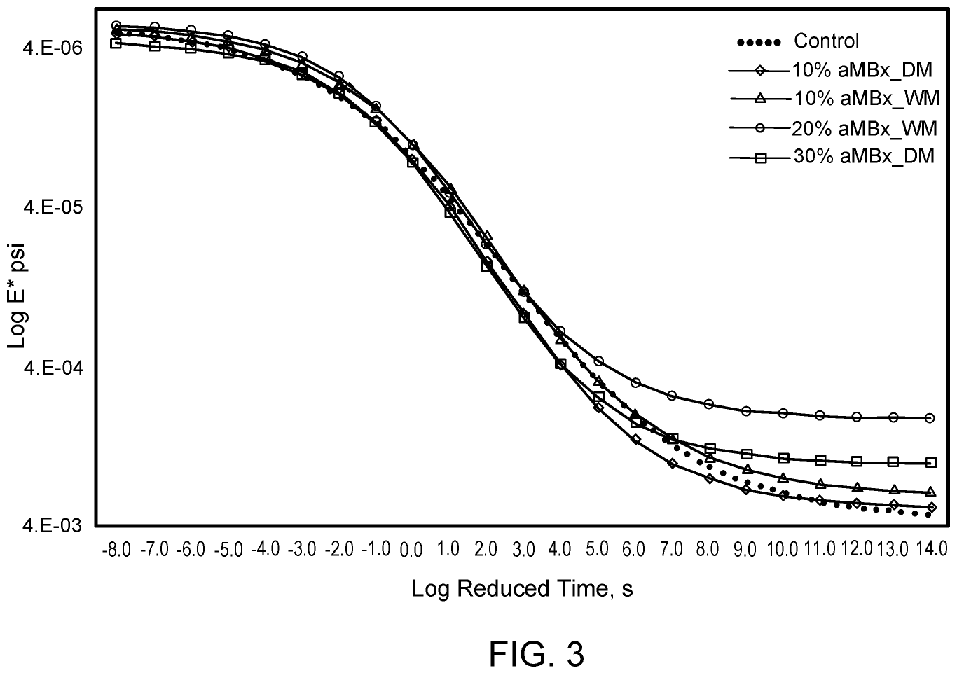

Dynamic Modulus Test. Test results of the Dynamic Modulus Test (E*, in pounds per square inch) are presented in FIG. 3, which shows the Master Curve for three asphalt mixtures. A master curve of an asphalt mixture provides a relationship between the mixture stiffness as a function of reduced frequency (or temperature). The stiffness changes from high values (low temperatures, left side) to lower values (high temperatures, right side). Analysis based on the master curves suggests that mixtures modified with aMBx present better rutting resistance (high temperature performance), and similar fatigue resistance (low temperature performance) than the control. aMBx modified mixtures have a higher modulus at high temperatures and low frequency than control. The higher modulus indicates a lower susceptibly to deformation and thus the modified mixtures are more stable at high temperatures. The properties of the 20% aMBx_WM mixture samples are better than the other mixtures, confirming the WM is a better mechanism to implement the aMBx in the mixtures.

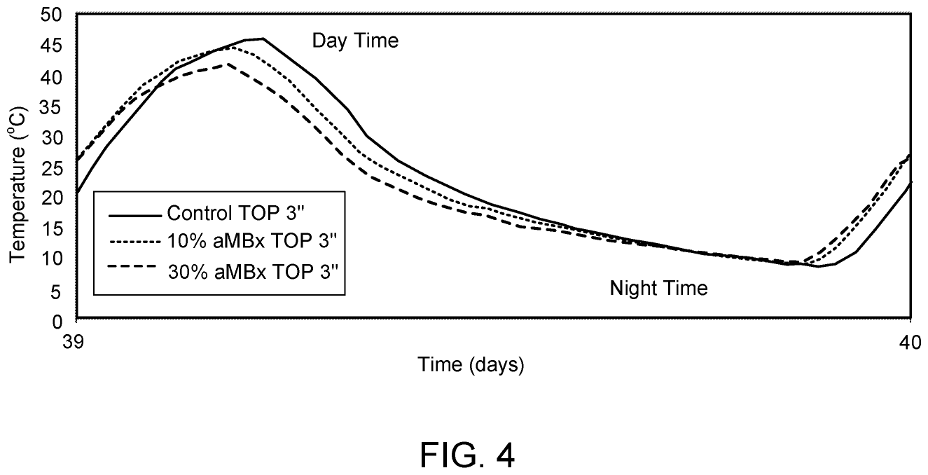

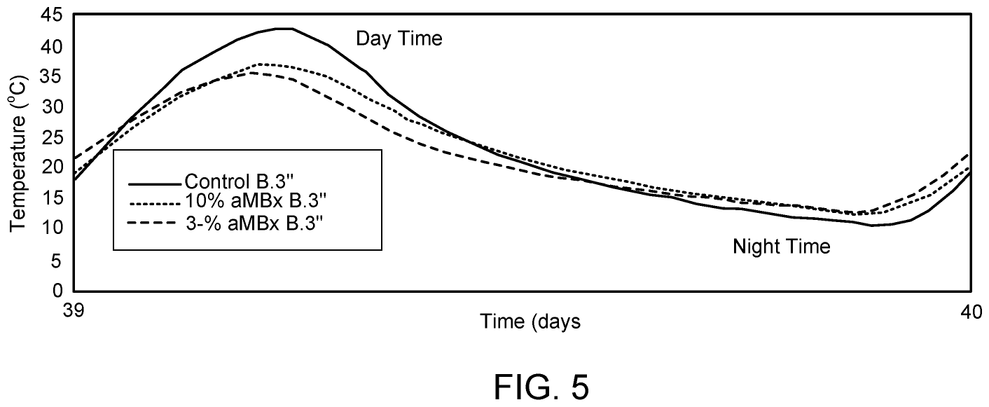

In-situ pavement temperatures. Thermocouples were installed at top and bottom of the unmodified pavement test sections and those modified with 10% aMBX and 30% aMBx by asphalt binder weight during the construction process. These sensors collected data every 30 minutes daily for pavements of 3 inch thick. Temperature readings have shown that the aMBx modified pavement is less susceptible or impacted by temperature fluctuation. The temperature fluctuation is lower in the range of 2-5° C. compared to the conventional (control) pavement (see FIGS. 4 and 5).

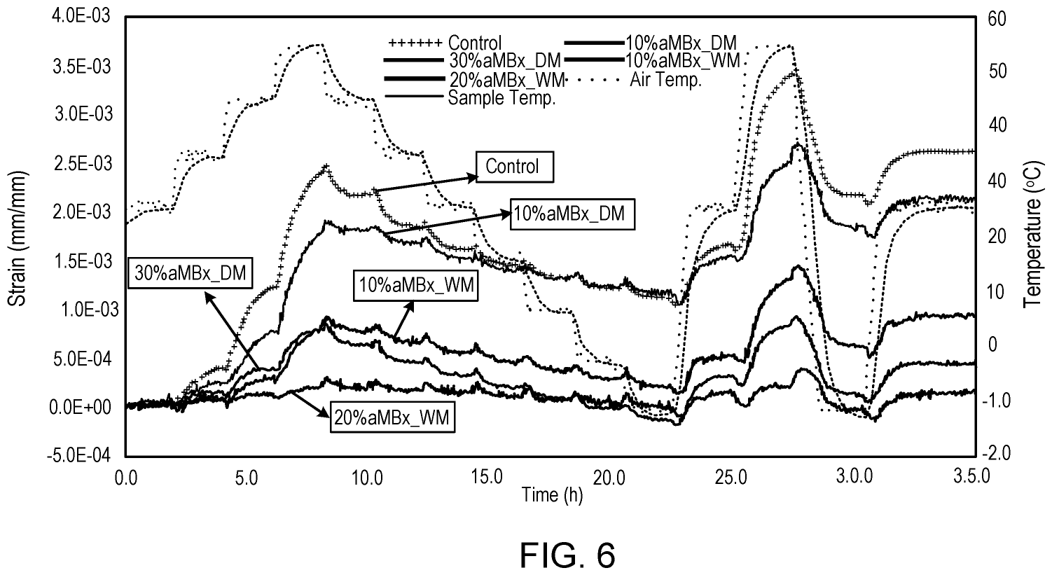

Expansion—Contraction Mixture Testing: An Expansion-Contraction laboratory test was conducted for a control, 10% aMBx_DM, 10% aMBx_WM, 20% aMBx_WM, and 30% aMBx DM mixture samples, where DM and WM indicate that the samples were prepared using the Dry Method and Wet Method, respectively. Results showed that mixtures modified with aMBx exhibit lower expansion and contraction compared to the control mixture. FIG. 6 shows the strain variation with the temperature change. Table 7 shows the values for the linear coefficients of expansion and contraction for the control and 30% aMBx modified mixtures. These coefficients suggest that the mixtures modified with aMBx are less susceptible to temperature changes. Lower strain development in the asphalt mixture can also translate to better field performance of the road/asphalt paving mixture.

TABLE 7
Coefficient of Linear Thermal Expansion-Contraction.

| | | | | | | | | | Coefficient |
|---|---|---|---|---|---|---|---|---|---|
| | Coefficient | | | | Coefficient | | | | of Thermal |
| | of Thermal | | | | of Thermal | | | | Expansion- |
| | Expansion | Standard | Standard | | Contraction | Standard | Standard | | Contraction |
| Mixture Type | αₑ 10⁻⁵/° C. | Deviation | Error | COV | α_{c} 10⁻⁵/° C. | Deviation | Error | COV | α_{ec} 10⁻⁵/° C. |
| Control | 3.486 | 0.355 | 0.205 | 0.102 | 2.449 | 0.228 | 0.132 | 0.093 | 2.967 |
| 10% aMBx_DM | 1.831 | 0.198 | 0.114 | 0.108 | 1.640 | 0.228 | 0.132 | 0.139 | 1.735 |
| 10% aMBx_WM | 1.455 | 0.191 | 0.110 | 0.131 | 1.105 | 0.138 | 0.080 | 0.125 | 1.280 |
| 20% aMBx_WM | 0.403 | 0.229 | 0.132 | 0.569 | 0.226 | 0.056 | 0.032 | 0.248 | 0.314 |
| 30% aMBx_DM | 1.450 | 0.388 | 0.224 | 0.267 | 1.393 | 0.238 | 0.138 | 0.171 | 1.421 |

ASHTOWare Pavement ME Analysis. The AASHTOWare Pavement Design software was used for the performance and durability analysis. The pavement design methodology is based on engineering mechanics and has been validated with extensive road test performance data. The software will predict the major distresses in a pavement structure such as Permanent Deformation (rutting), Fatigue, Thermal Cracking and Roughness in terms or International Roughness Index (IRI). It uses various input parameters, such as the dynamic modulus of the asphalt mixture and the mix design volumetric properties. The generated results of this software are the distresses prediction over time. Such predictions can help designers and pavement engineers predict the performance of designed pavements over a period of years.

The level of analysis used for permanent deformation was Level 1, where binder and mixture design parameters are needed. For thermal cracking, level 3 analysis was used and the thermal parameters were input (expansion and contraction, specific heat capacity and thermal conductivity). Three typical scenarios were considered for the AASHTOWare Pavement ME analysis, including different infrastructures and traffic levels. Those scenarios also depend on the type of subgrade, traffic level, and thicknesses of asphalt and base layers. Two different climatic regions were analyzed: Phoenix and Chicago. These regions are different in climate throughout the years and are used to predict the effect of aMBx modified asphalt mixture on distresses for hot and cold climates. An average service life of 20 years was used for the analysis. Table 8 presents the different scenarios and input parameters discussed in the previous sections (PD refers to Permanent deformation) for control, 10% aMBx_DM, 10% aMBx_WM, 20% aMBx_WM, and 30% aMBx_DM.

TABLE 8
AASHTOWare Pavement ME Generated Results Summary

| | | | | Total | | | | AC |
|---|---|---|---|---|---|---|---|---|
| | | | | Permanent | | Thermal | Top-Down | Permanent |
| | Design | | IRI | Deformation | Fatigue | Cracking | Fatigue | Deformation |
| Climate | Type | Mixture | (m/Km) | (cm) | (% Lane) | (m/Km) | (% Lane) | (cm) |
| Chicago | Thin | Control | 2.77 | 1.37 | 28.18 | 588.92 | 17.23 | 0.28 |
| | | 10% D | 2.77 | 1.35 | 28.18 | 466.32 | 16.20 | 0.26 |
| | | 10% W | 2.73 | 1.32 | 28.19 | 385.32 | 15.14 | 0.25 |
| | | 20% W | 2.30 | 1.14 | 16.31 | 59.88 | 4.69 | 0.15 |
| | | 30% D | 2.60 | 1.35 | 27.12 | 342.26 | 12.12 | 0.24 |
| | Thick | Control | 2.61 | 0.89 | 1.66 | 588.92 | 14.19 | 0.15 |
| | | 10% D | 2.55 | 0.91 | 1.73 | 490.26 | 14.13 | 0.18 |
| | | 10% W | 2.52 | 0.86 | 1.57 | 412.36 | 14.07 | 0.13 |
| | | 20% W | 2.21 | 0.74 | 1.46 | 47.35 | 14.28 | 0.05 |
| | | 30% D | 2.37 | 0.91 | 1.72 | 289.47 | 13.88 | 0.16 |
| Phoenix | Thin | Control | 2.80 | 1.32 | 25.93 | 605.56 | 12.23 | 0.51 |
| | | 10% D | 2.80 | 1.30 | 26.23 | 578.56 | 12.00 | 0.48 |
| | | 10% W | 2.69 | 1.27 | 23.46 | 401.04 | 11.78 | 0.43 |
| | | 20% W | 2.44 | 0.99 | 14.48 | 83.46 | 11.35 | 0.23 |
| | | 30% D | 2.62 | 1.30 | 25.33 | 325.30 | 11.15 | 0.48 |
| | Thick | Control | 2.33 | 0.97 | 2.19 | 587.28 | 11.35 | 0.36 |
| | | 10% D | 2.25 | 1.00 | 2.55 | 424.51 | 11.29 | 0.35 |
| | | 10% W | 2.14 | 0.89 | 1.83 | 339.19 | 11.22 | 0.30 |
| | | 20% W | 1.89 | 0.66 | 1.46 | 83.45 | 11.23 | 0.10 |
| | | 30% D | 2.11 | 1.01 | 2.58 | 256.66 | 11.13 | 0.35 |

Use of aMBx in the asphalt mixture is shown to result in decrease in the accumulation of distresses (e.g., permanent deformation, fatigue, and IRI). The thermal cracking development potential is improved. However, when the Wet Method was implemented, the decrease is greater at 20% aMBx. The same trend is evident with respect to other distresses. The 30% aMBx mixture has very similar behavior to the control in all the pavement distresses mentioned except for the thermal cracking. This trend highlights the thermal and physical benefits of adding aMBx to asphalt mixtures. Thermal cracking can occur due to stress development within the asphalt layer as a result of the expansion and contraction of the layers. These movements are caused due to temperature changes, affecting the pavement layer. A crack can form when the stress buildup exceeds the strength of the layer. The asphalt mixture laboratory tests and results obtained from AASHTOWare Pavement ME analysis show that adding the aMBx modifier decreases the temperature susceptibility of the asphalt mixture and thus its susceptibility to thermal cracking.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An aerogel composite comprising:
aerogel particles; and
an encapsulator,
wherein the aerogel particles are coated with the encapsulator to yield an aerogel composite.

2. The composite of claim 1, wherein the aerogel particles comprise silica, carbon, metal oxide, polymer-crosslinked aerogels, or any combination thereof.

3. The composite of claim 1, wherein a particle size of the aerogel is in a range between 0.005 mm and 2 mm.

4. The composite of claim 1, wherein the encapsulator comprises a heavy oil product, an asphalt binder, a synthetic polymer, an organic polymer, or any combination thereof.

5. The composite of claim 4, wherein the organic polymer comprises a bio-derived compound, a bio-oil, lignin, industrial lignin, tree resin, or any combination thereof.

6. The composite of claim 1, wherein a particle size of the aerogel composite is in a range between 0.01 mm and 3 mm.

7. The composite of claim 1, comprising a weight ratio of aerogel to encapsulator in a range between 10:90 and 90:10.

8. A method of making an aerogel composite, the method comprising:
combining an encapsulator and aerogel particles;
mixing the encapsulator and the aerogel particles to yield a granular blend comprising coated aerogel particles; and
increasing a rate of mixing over a length of time to yield the aerogel composite.

9. The method of claim 8, wherein the encapsulator comprises a heavy oil product, an asphalt binder, a synthetic polymer, an organic polymer, or any combination thereof.

10. The method of claim 9, wherein the organic polymer comprises a bio-derived compound, a bio-oil, lignin, industrial lignin, tree resin, or any combination thereof.

11. The method of claim 8, wherein the aerogel particles comprise silica, carbon, metal oxide, polymer-crosslinked aerogels, or any combination thereof.

12. The method of claim 8, wherein a particle size of the aerogel particles is in a range between 0.005 mm and 2 mm.

13. The method of claim 8, wherein a particle size of the aerogel composite is in a range between 0.01 mm and 3 mm.

14. The method of claim 8, wherein a weight ratio of the aerogel to the encapsulator is in a range between 10:90 and 90:10.

15. The method of claim 8, comprising heating the granular blend to a temperature in a range between 180° C. and 210° C.

16. The method of claim 8, comprising increasing the rate of mixing from 750 RPM to 3500 RPM.

17. The method of claim 8, wherein the length of mixing time is between 1 minute and 10 minutes.

18. A method of modifying bituminous material, the method comprising:
heating the bituminous material;
combining the aerogel composite of claim 1 with the bituminous material;
mixing the aerogel composite and the bituminous material to uniformly distribute the aerogel composite in the bituminous material.

19. The method of claim 18, wherein a weight ratio of the aerogel composite to the bituminous material is in a range between 10:90 and 90:10.

20. A method of making an asphalt mixture, the method comprising:
combining the aerogel composite of claim 1, an asphalt binder, and aggregate to yield the asphalt mixture.

21. The method of claim 20, further comprising:
combining the aerogel composite and the asphalt binder to yield an aerogel composite binder mixture; and
combining the aerogel composite binder mixture with the aggregate to yield the asphalt mixture.
